(19) United States
(12) Patent Application Publication
(10) Pub. No.: US 2011/0271754 A1
(43) Pub. Date: Nov. 10, 2011

(54) Liquid Level Transducer with Heating Unit

(75) Inventors: Herbert G. Ross, JR., Argyle, TX (US); Gagik Farmanyan, Plano, TX (US); Hovhannes Chibukhchyan, Plano, TX (US)

(73) Assignee: ROCHESTER GAUGES, INC., Dallas, TX (US)

(21) Appl. No.: 13/100,975

(22) Filed: May 4, 2011

Related U.S. Application Data
(60) Provisional application No. 61/330,969, filed on May 4, 2010.

(51) Int. Cl. G01F 23/00

(52) U.S. Cl. 73/295

(57) ABSTRACT

A transducer for determining the liquid level within a container that is subjected to at least partial solidification at or below a freezing temperature is provided. The transducer includes a mounting head adapted for connection to the container, a liquid level sensor adapted for extending into the container from the mounting head; and a heating unit extending through the mounting head. The heating unit is constructed of at least one tubular member that surrounds or encircles the liquid level sensor. Heated fluid from a fluid source is circulated through the at least one tubular member for heating the contents of the tank at least within the vicinity of the liquid level sensor. A fluid withdrawal tube can also be in close proximity to the at least one tubular member so that the contents of the tank surrounding the heating unit can be removed even when the remaining tank contents are in a frozen state.

### CROSS-REFERENCE TO RELATED APPLICATIONS

This application claims the benefit of U.S. Provisional Application No. 61/330,969 filed on May 4, 2010, the disclosure of which is hereby incorporated by reference in its entirety.

### BACKGROUND OF THE INVENTION

This invention relates to liquid level transducers, and more particularly to liquid level transducers having heating arrangements for heating the surrounding material to be measured.

Transducers for measuring liquid level are often used in vehicles, industrial equipment as well as other mobile and stationary systems and components. The electrical output of such transducers changes in response to a change in the liquid level being measured and is typically in the form of a change in resistance, capacitance, current flow, magnetic field, and frequency. These types of transducers may include variable capacitors or resistors, optical components, Hall Effect sensors, strain gauges, ultrasonic devices, reed switch arrays, and so on.

No matter what transducer type is used, the tank level measurement is most successful when the material being measured is in a liquid state as opposed to a semi-solid or frozen state. Although many fuels have a freezing point well below the operating temperature range of most vehicles and equipment, other fluids are subjected to freezing such as engine coolant and diesel exhaust fluid (DEF). DEF is especially problematic since it is used in vehicles equipped with Selective Catalytic Reduction (SCR) systems. DEF is a solution that typically comprises purified water and approximately 32.5 percent urea and is used to reduce nitrogen oxide (NOx) emissions from diesel-powered vehicles into nitrogen, water and carbon dioxide (CO₂). The DEF is kept in a tank on the vehicle and is automatically accessed during vehicle operation to reduce emissions. A liquid level transducer is often associated with the tank to indicate a level of the DEF to an operator or other observer. Unfortunately, the DEF can freeze when subjected to low temperature conditions and thus cannot be accurately measured or extracted from the tank until it is changed to a liquid state.

Prior art solutions have been inadequate in addressing these problems in a satisfactory manner. It would therefore be desirous to provide a heating arrangement associated with the liquid level transducer and/or liquid withdrawal or supply tubes of DEF tanks or the like so that the level of DEF can be more quickly ascertained and accessed during freezing conditions.

### SUMMARY OF THE INVENTION

In accordance with one aspect of the invention, a transducer for determining the level of contents within a container wherein the contents are subjected to solidifying below a freezing temperature is provided. The transducer includes: a mounting head adapted for connection to the container; a liquid level sensor adapted to extend into the container from the mounting head; and a spiral-shaped heating unit comprising a first elongate tube extending through the mounting head. The first elongate tube is formed with at least one coil that surrounds at least a portion of the liquid level sensor and is adapted to circulate heating fluid therein to thereby heat the contents of the container at least in the vicinity of the liquid level sensor.

In accordance with a further aspect of the invention, a transducer for determining liquid level within a container includes: a mounting head adapted for connection to the container; a liquid level sensor adapted for extending into the container from the mounting head; and a heating tube extending through the mounting head. The heating tube has: first and second upright segments connected via a first lower bend; a third upright segment connected to the second upright segment via an upper bend; and a fourth upright segment connected to the third upright segment via a second lower bend. The first and fourth upright segments are adapted for fluid connection to a fluent heating source for heating the contents of the container.

In accordance with yet another aspect of the invention, a transducer for determining the level of contents within a container wherein the contents are subjected to solidifying below a freezing temperature is provided. The transducer includes: a mounting head adapted for connection to the container; a liquid level sensor adapted for extending into the container from the mounting head; and a heating unit extending through the mounting head and into the container. The heating unit has an outer tube and an inner tube extending inside and along a length of the outer tube. The outer and inner tubes are in fluid communication such that heating fluid is adapted to flow from one of the outer and inner tubes to the other of the outer and inner tubes to thereby heat the contents of the container.

### BRIEF DESCRIPTION OF THE DRAWINGS

The following detailed description of the preferred embodiments of the present invention will be best understood when considered in conjunction with the accompanying drawings, wherein like designations denote like elements throughout the drawings, and wherein:

FIG. 1 is a front isometric view of a liquid level transducer with a heat transfer unit connected to a tank in accordance with on embodiment of the present invention;

FIG. 2 is a side elevational view thereof;

FIG. 3 is a view similar to FIG. 1 with the tank removed;

FIG. 4 is a view similar to FIG. 3 with a mounting plate removed to reveal the details of an upper portion of the liquid level transducer;

FIG. 5 is top isometric view of the liquid level transducer;

FIG. 6 is a view similar to FIG. 5 with a housing portion removed to reveal the details of the upper portion of the liquid level transducer;

FIG. 7 is a view similar to FIG. 6 with a transfer block removed to reveal more details of an end portion of the liquid level transducer;

FIG. 8 is an enlarged bottom isometric view of the liquid level transducer;

FIG. 9 is a bottom perspective view of the liquid level transducer;

FIG. 10 is a front elevational view of a liquid level transducer with a heat transfer unit in accordance with a further embodiment of the present invention;

FIG. 11 is a rear elevational view thereof;

FIG. 12 is a top perspective view thereof;

FIG. 13 is a side perspective view of an upper portion of the liquid level transducer of FIG. 10;

FIG. 14 is a left side elevational view of an upper portion thereof;

FIG. 15 is a right side elevational view of an upper portion thereof;

FIG. 16 is a front elevational view of a lower portion of the liquid level transducer of FIG. 10;

FIG. 17 is left side elevational view of the lower portion thereof;

FIG. 18 is a top schematic view of a tank and the heat transfer unit of FIG. 10 for comparing the size of the opening with the heat transfer unit;

FIG. 19 is a front isometric view of a liquid level transducer with a heat transfer unit connected to a tank in accordance with a further embodiment of the present invention;

FIG. 20 is a sectional view of a heat transfer unit in accordance with yet another embodiment of the invention;

FIG. 21 is a sectional view thereof taken along line 21-21 of FIG. 20;

FIG. 22 is a front elevational view of a liquid level transducer with heat transfer unit in accordance with a further embodiment of the invention; and

FIG. 23 is an enlarged view of a portion of the heat transfer unit of FIG. 22.

It is noted that the drawings are intended to depict only exemplary embodiments of the invention and therefore should not be considered as limiting the scope thereof. It is further noted that the drawings are not necessarily to scale. The invention will now be described in greater detail with reference to the accompanying drawings.

### DETAILED DESCRIPTION OF THE INVENTION

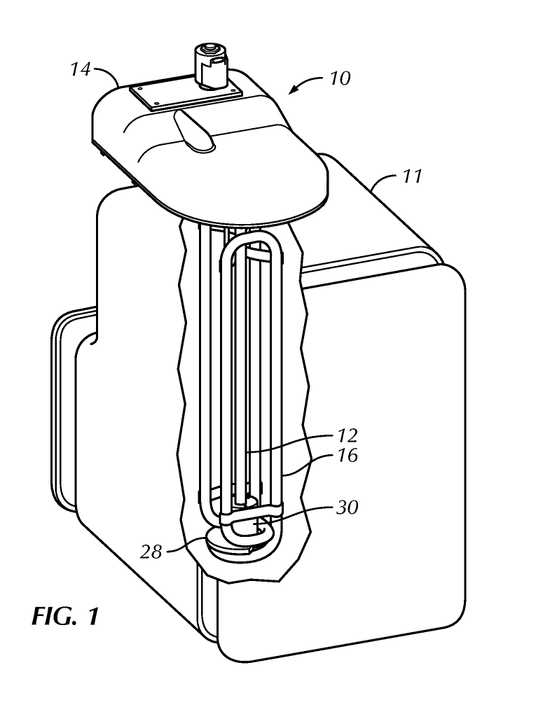

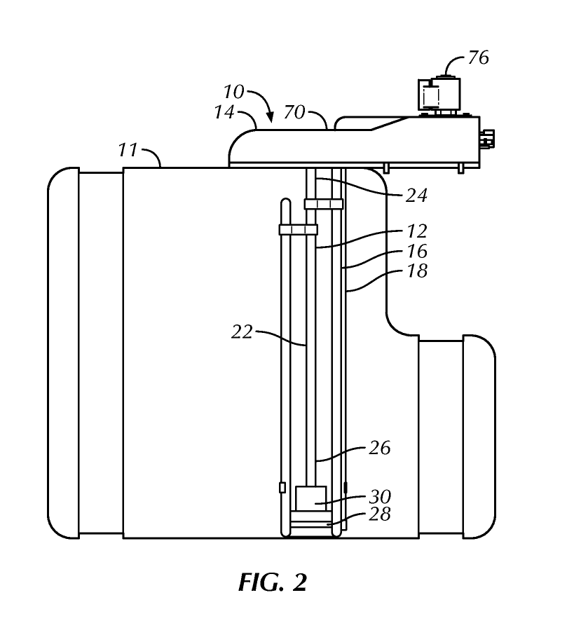

Referring now to the drawings, and to FIGS. 1 and 2 in particular, a liquid level transducer 10 according to an exemplary embodiment of the present invention is illustrated. The liquid level transducer 10 preferably extends into a container 11, such as a fuel tank, oil reservoir, radiator, brake fluid chamber, or any other container for holding and/or transporting a liquid (not shown). In accordance with one preferred application of the invention, the transducer 10 is particularly useful for liquids that have a tendency to freeze at lower temperatures, such as diesel exhaust fluids (DEF) in a NOx emissions control system. Such fluids can include, but are not limited to, water, urea, ammonia, and combinations thereof.

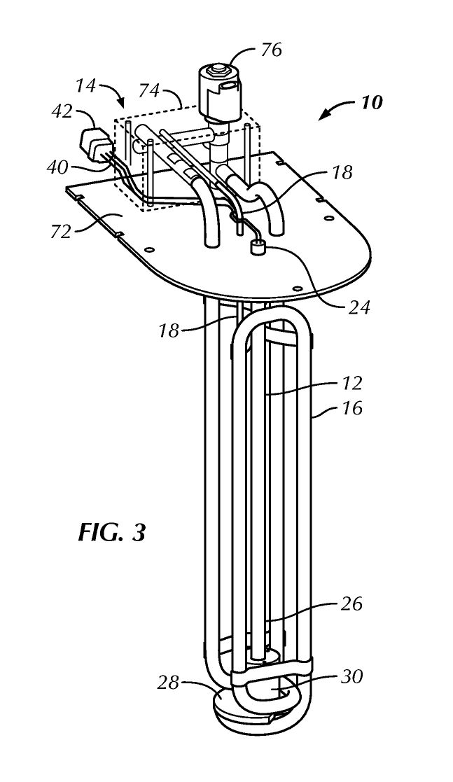

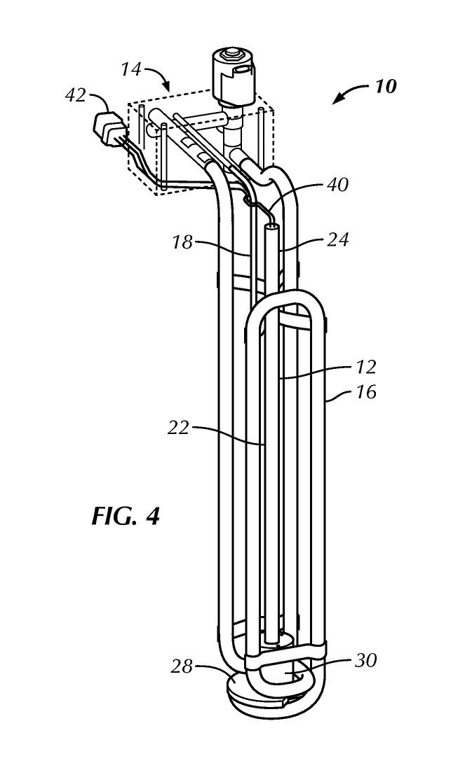

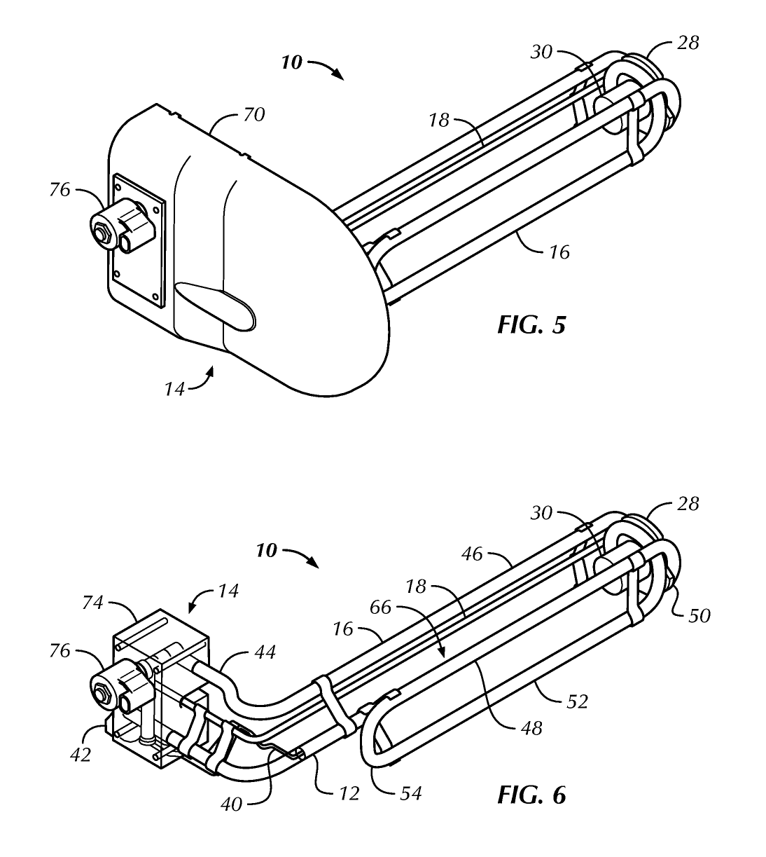

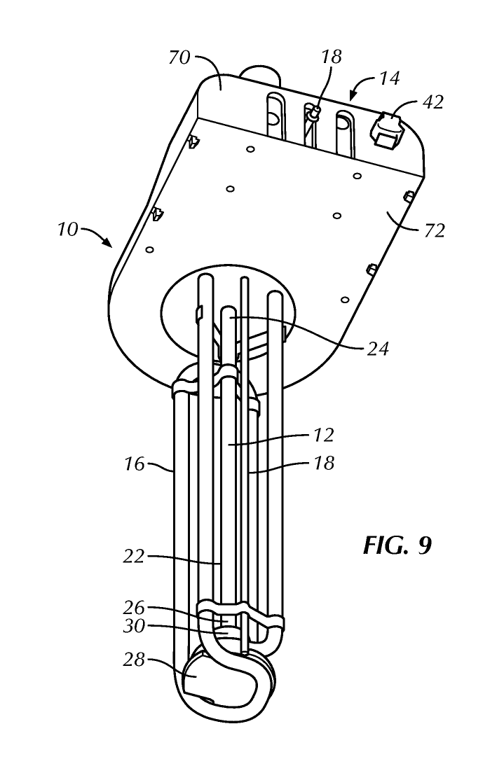

With additional reference to FIGS. 3-5 and 9, the transducer 10 preferably includes a mounting head 14, an elongate sensing probe 12 extending through the mounting head 14 and downwardly therefrom, a heating unit 16 extending through the mounting head 14 and bending around the sensing probe 12, and a fluid supply tube 18 extending through the mounting head 14 and along a substantial length of the heating unit 16.

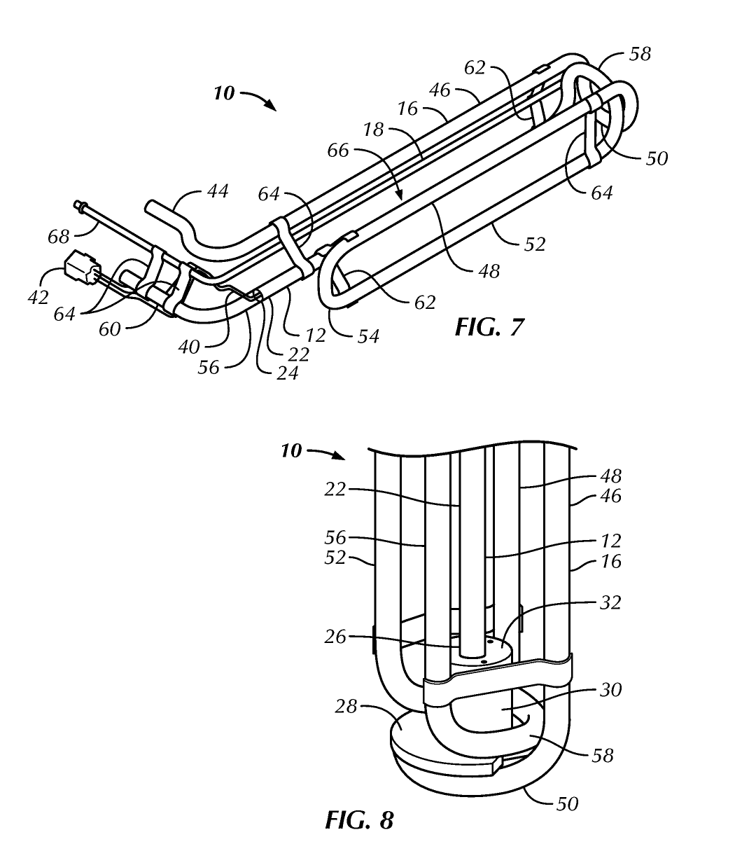

As best shown in FIGS. 2-4 and 6-8, the sensing probe 12 preferably senses liquid level in a linear direction and, in accordance with one preferred embodiment of the invention, includes an outer sensor tube 22 with an upper end 24 that extends through the mounting head 14 and a lower end 26 with a support block 28. A float 30 is preferably cylindrically-shaped and includes a central bore 32 (shown in FIG. 8) that is sized to receive the sensor tube 22 so that the float slides freely therealong. The support block 28 preferably holds the heating unit 16, the lower end 26 of the sensor tube 22, and preferably serves as a lower resting position for the float 30 in the event of a very low level or empty tank condition. A printed circuit board (PCB—not shown) is positioned within the sensor tube 22 and preferably extends along a substantial length thereof. A plurality of reed switches (not shown) are located along the length of the PCB. The reed switches are responsive to one or more magnets (not shown) located in the float 30 for creating a liquid level signal in a well-known manner as the float rides along the sensor tube 22 in response to a change in liquid level within the tank. Although not shown, insulating material, such as heat-shrink tubing, potting material, and so on, is preferably located between the PCB and the sensor tube 22 to insulate and protect the reed switches and other components against shock, vibration, and other harsh conditions to which the transducer 10 may be exposed. Potting material (not shown) may also be located at the upper end 24 of the sensor tube 22 to provide strain relief for the electrical wires 40 (FIGS. 3, 4, 6 and 7) that extend between the PCB and an electrical connector 42, as well as vibration protection for the PCB and its interface with the wires.

It will be understood that the sensor tube 22 can also contain other sensors besides liquid level, in particular temperature, which would provide information to the heating circuit for controlling circulation of the heating fluid through the heating unit 16. Wiring connections and any circuitry required for the sensing is preferably located within the sensor tube and inside a sealed compartment within the mounting head 14 and sensor tube connection.

Although a reed-switch-type probe has been shown and described, it will be understood that the present invention is not limited thereto. It will be understood that other linear-type liquid level measurement sensors can be used, including but not limited to, capacitance, heated wire, ultrasonic, optical, and so on, as well as non-linear-type sensors such as resistance-type pivoting float arms.

As best shown in FIGS. 6-8, the heating unit 16 preferably includes a single piece or length of tube that is bent into the tortuous shape as shown and includes a first upper segment 44 that extends generally horizontally and is fluidly connected to a fluent heat source (not shown) such as such as engine coolant, oil, hot exhaust gases and so on, in order to provide constant or selective intermittent circulation of heating fluid to warm the contents of the tank 11 (FIG. 1). A first upright leg 46 extends generally vertically downwardly from the first upper segment 44 and is connected to a second generally vertically extending upright leg 48 via a first lower generally U-shaped bend 50 extending therebetween. A third generally vertically extending upright leg 52 is in turn connected to the second leg via an upper generally U-shaped bend 54. Likewise, a fourth generally vertically extending upright leg 56 is in turn connected to the third leg 52 via a second lower generally U-shaped bend 58 that is vertically higher than the first bend 50. The first and second lower U-shaped bends 50, 58 are preferably connected to the support block 28 for providing stability at the lower end of the transducer 10. The fourth leg 56 is in turn fluidly connected to a second generally horizontally extending upper segment 60, which is in turn fluidly connected to the fluent heat source.

In order to eliminate the need for an internal tank restraint and provide greater structural integrity for the transducer 10, the sensor tube 22 and fluid supply tube 18 are preferably securely connected to the heating tube 16 and to each other via clips 62 and 64. However, it will be understood that the parts can be connected together through any well-known connection means, including but not limited to, adhesives, welding, other types of mechanical fastening, and so on.

A substantial portion of the fluid supply tube 18 preferably extends adjacent to the first leg 46 of the heating tube 16. However, it will be understood that the supply tube 18 can alternatively be located adjacent to the fourth leg 56. The supply tube 18 preferably includes a generally horizontally extending upper segment 68 that extends through the mounting head 14. The supply tube 18 is adapted for connection to a pump (not shown) or the like in a well-known manner for delivering liquid from the tank 11 to a remote location. The supply tube 18 preferably extends to an empty level position inside the tank adjacent to the lower U-shaped bends 50, 58. If desired, a filter (not shown) can be located at the lower end of the supply tube 18 inside the tank.

The tortuous shape of the heating tube 16 is particularly advantageous since the four upright legs 46, 48, 52 and 56 increase the amount of heating tube surface area installed in the tank and create a space or volume 66 within the tank 11 that is more quickly heated than the surrounding area. When the heating tube carries warm fluid, such as engine coolant, the heat transferring from the heating tube is used to thaw or prevent freezing of the tank contents surrounding the sensor as well as the supply tube 18 located within the space 66. Increasing the amount of surface area of the heating tube 16 increases the amount of heat transfer in a given amount of time. This reduces the potential for freezing of the tank contents in the area of the sensor and supply tubes at lower temperatures and causes quicker thawing of the contents at a given temperature than if the heating tube 16 were constructed with less segments.

As shown in FIGS. 3-6 and 9, the mounting head 14 preferably includes a cover 70 connected to a mounting plate 72 which is in turn connected to the tank 11 (FIG. 1). The cover 70 together with the mounting plate 72 create a hollow interior through which the segments 44, 60 of the heating tube 16 and the segment 68 of the supply tube 18 preferably extend. A transfer block 74 is secured to the mounting plate 72 and includes passages for receiving the heating tube and supply tube segments, as well as an opening for receiving the electrical wires 40 and connector 42. A valve assembly 76 extends into the transfer block 74 and is in fluid communication with the segment 44 of the heating tube and the fluent heating source (not shown).

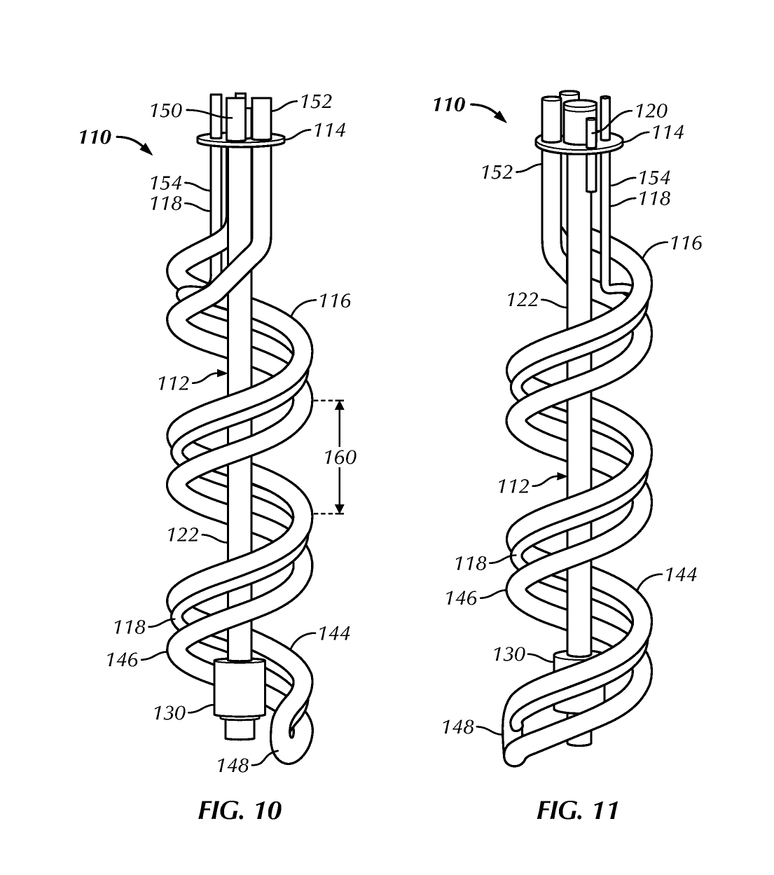

Referring now to FIGS. 10 and 11, a liquid level transducer 110 in accordance with a further exemplary embodiment of the invention is illustrated. The liquid level transducer 110 preferably extends into a container (not shown), such as a fuel tank, oil reservoir, radiator, brake fluid chamber, or any other container for holding and/or transporting a liquid (not shown). In accordance with one preferred application of the invention, the transducer 110 is particularly useful for liquids that have a tendency to freeze at lower temperatures, such as diesel exhaust fluids (DEF) in a NOX emissions control system. Such fluids can include, but are not limited to, water, urea, ammonia, and combinations thereof.

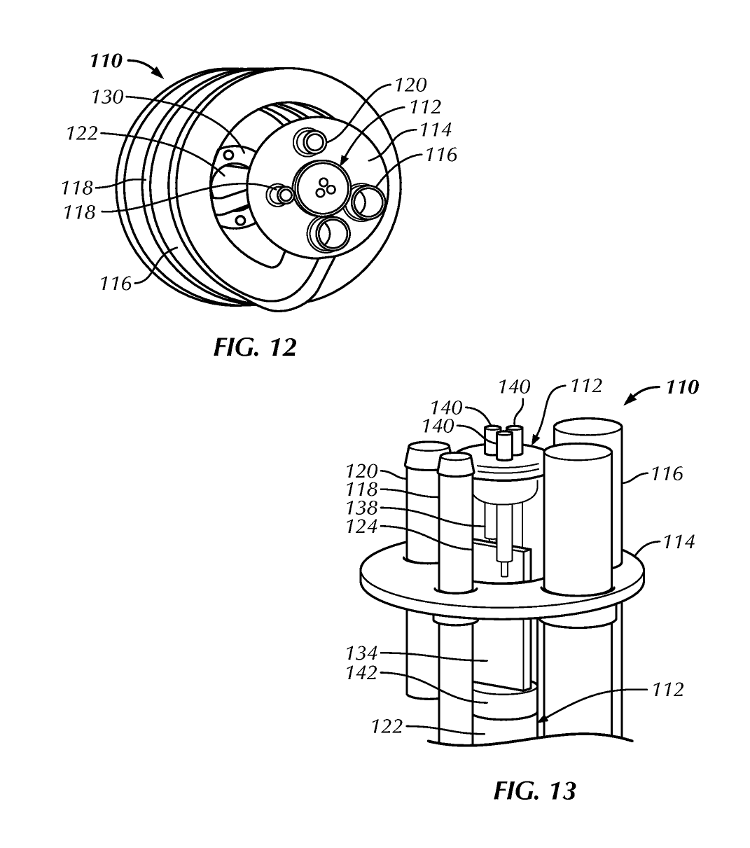

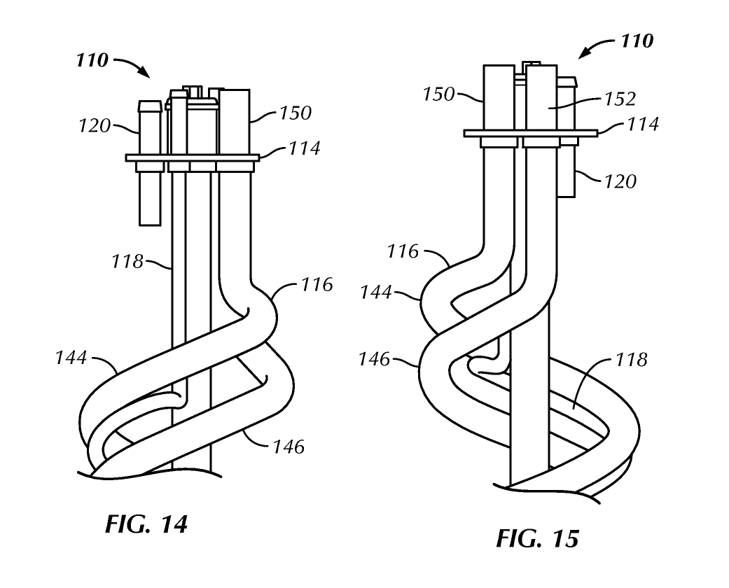

With additional reference to FIG. 12-15, the transducer 110 preferably includes a mounting head 114, an elongate sensing probe 112 extending through the mounting head 114 and downwardly therefrom, a helically-shaped heating unit 116 extending through the mounting head 114 and spiraling around the sensing probe 112, a fluid supply tube 118 extending through the mounting head 114 and along a substantial length of the heating unit 116, and a liquid return tube 120 extending through the mounting head 114.

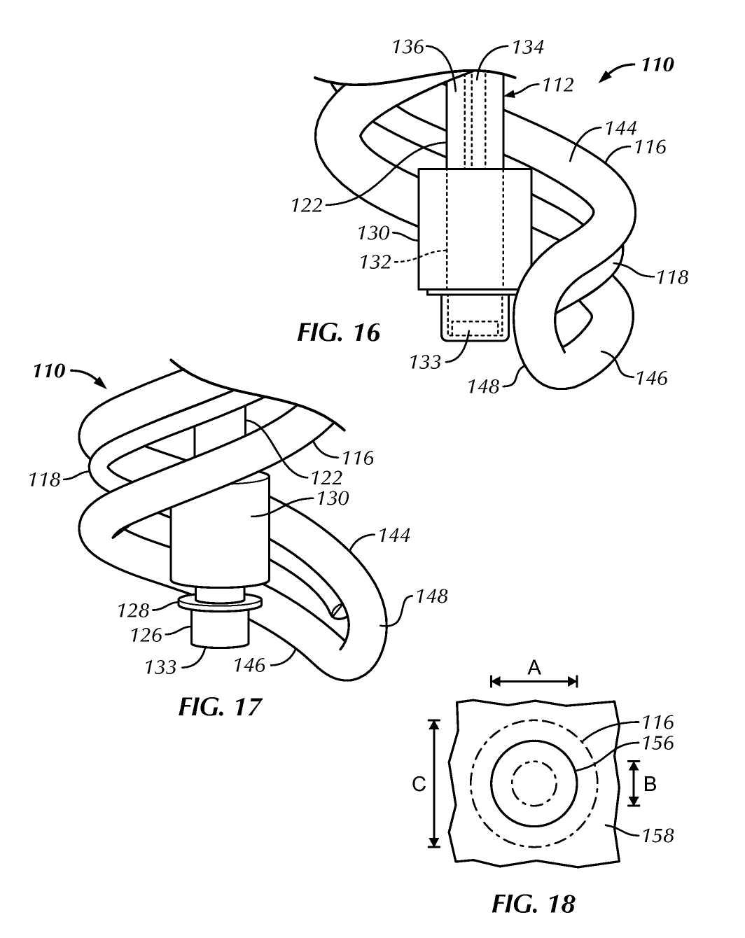

As best shown in FIGS. 10, 11, 13, 16 and 17, the sensing probe 112 preferably senses liquid level in a linear direction and, in accordance with one preferred embodiment of the invention, includes an outer sensor tube 122 with an upper end 124 that extends through the mounting head 114 and a lower end 126 with a stop flange 128. A float 130 is preferably cylindrically-shaped and includes a central bore 132 (shown in hidden line in FIG. 16) that is sized to receive the sensor tube 122 so that the float slides freely therealong. The stop flange 128 provides a lower resting position for the float 130 in the event of a very low level or empty tank condition.

A printed circuit board (PCB) 134 is positioned within the sensor tube 122 and preferably extends along a substantial length thereof. A plurality of reed switches (not shown) are located along the length of the PCB 134. The reed switches are responsive to one or more magnets (not shown) located in the float 130 for creating a liquid level signal in a well-known manner as the float rides along the sensor tube 122 in response to a change in liquid level within the tank.

Insulating material 136, such as heat-shrink tubing, potting material, and so on, is preferably located between the PCB 134 and the sensor tube 122 to insulate and protect the reed switches and other components against shock, vibration, and other harsh conditions to which the transducer 110 may be exposed. Potting material 138 (FIG. 13) is located at the upper end 124 of the sensor tube 122 to provide strain relief for the electrical wires 140 and vibration protection for the PCB 134 and its interface with the wires. A potting grommet 142 is received over the PCB 134 for limiting the height of the potting material during assembly and curing. A cushion 133 (FIG. 17) is preferably located with the sensor tube 122 and surrounds the PCB 134 below the stop flange 138 for providing further protection against vibration and undesired forces that may otherwise be present on the PCB during shipping, installation and/or operation. The sensor tube 122 can also contain other sensors besides liquid level, in particular temperature, which would provide information to the heating circuit for controlling circulation. Wiring connections and any circuitry required for the sensing is preferably located within the sensor tube and inside a sealed compartment above the mounting head 114 and sensor tube connection.

Although a reed switch type probe has been shown and described, it will be understood that the present invention is not limited thereto. Other linear-type liquid level measurement sensors can be used, including but not limited to, capacitance, heated wire, ultrasonic, optical, pivoting float arm, and so on, as well as non-linear-type sensors such as resistance-type pivoting float arms.

As best shown in FIGS. 10, 11 and 14-17, the heating unit 116 is preferably in the form of a single, elongate tube with a first leg 144 and a second leg 146 and a generally U-shaped bend 148 extending therebetween. The first and second legs 144 and 146 include straight upper segments 150 and 152, respectively, that extend through the mounting head 114. The upper ends of the segments 150, 152 are adapted for connection to supply and return conduits (not shown) of a fluent heat source, such as such as engine coolant, oil, hot exhaust gases and so on, in order to provide constant and/or intermittent circulation of heating fluid to warm the contents of the tank (not shown). In order to eliminate the need for an internal tank restraint and provide greater structural integrity for the transducer 110, the sensor tube 122 is preferably securely connected to the heating tube 116. When the sensor tube and heating tube are constructed of metallic material, such as stainless steel, the parts are preferably welded together. However, it will be understood that the parts can be connected together through any well-known connection means, including but not limited to, adhesives, ultrasonic welding, mechanical fastening, and so on.

A substantial portion of the fluid supply tube 118 is preferably connected to the first leg 144 of the heating tube 116 and thus spirals around the sensing probe therewith. However, it will be understood that the supply tube 118 can alternatively be connected to the second leg 146. The supply tube 118 preferably includes a straight upper segment 154 that extends through the mounting head 114. The supply tube 118 and return tube 120 are adapted for connection to a pump or the like in a well-known manner for delivering liquid from the tank (not shown) on which the transducer is mounted to a remote location and returning unused liquid back into the tank.

The extension of the fluid supply and return tubes into the tank can be inside of the helical heating tube 116 or parallel on the same diameter. The fluid return tube does not have to extend far into the tank, but can if desired. The supply tube 118 preferably extends into the tank to the empty level inside the tank adjacent the U-shaped bend 148. If desired, a filter (not shown) can be located at the lower end of the supply tube 118 inside the tank.

As shown in FIGS. 10 and 18, the helical configuration of the heating tube 116 is especially advantageous in that the helical coil can be made larger in diameter than the mounting head 114 (FIG. 10) and the opening 156 (FIG. 18) in the tank wall 158 to which the transducer 110 is mounted. As shown in FIG. 18, the major or outside diameter C of the heating tube 116 is larger than the diameter A of the tank opening 156, which is in turn larger than the minor or inside diameter B of the heating tube 116. By way of example, and in accordance with a preferred embodiment of the invention, the maximum major diameter C can be calculated as follows:

C=A+(A−B)

For a 5-inch tank opening A and a 2.5-inch minor diameter B, the major diameter C of the heating tube 116 is approximately 7.5 inches, a significantly larger heating tube area that the contents of the tank will be exposed to over prior art solutions.

As shown in FIG. 10, the distance or spacing 160 between adjacent coils is preferably greater than a thickness of the tank wall 158 (FIG. 18) to which the transducer 110 will be mounted so that the thickness of the tank wall at the tank opening 156 can be cleared during the installation process. In this manner, the transducer 110 can be screwed into a tank opening 156, preferably with the float lifted to the upper portion of the sensing tube 122 just below the mounting head 114, with the tank opening being much smaller in diameter than the outside diameter of the coils of the helically-shaped heating tube 116. With a larger diameter helically-shaped heating tube 116, the amount of heater tubing surface area installed in the tank is significantly increased. When the coil carries warm fluid, such as engine coolant, the heat transferring from the coil is used to thaw or prevent freezing of the tank contents surrounding the sensor as well as the supply and return tubes. Increasing the amount of surface area of the heater tubing increases the amount of heat transfer in a given amount of time. This reduces the potential for freezing of the tank contents in the area of the sensor and supply tubes at lower temperatures and causes quicker thawing of the contents at a given temperature than if the coils of the heating tube 116 were constructed with a smaller diameter.

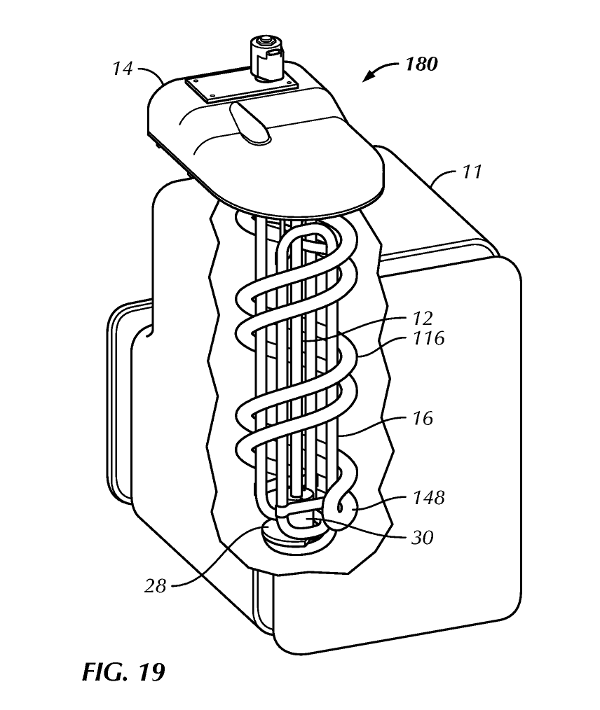

Referring now to FIG. 19, a liquid level transducer 180 in accordance with yet another embodiment of the invention is illustrated. The liquid level transducer 180 preferably extends into a container 11 and preferably includes a mounting head 14, an elongate sensing probe 12 extending through the mounting head 14 and downwardly therefrom with a float 30 movable along the length of the probe 12 as previously described, a first or inner heating unit 16 extending through the mounting head 14 and bending around the sensing probe 12, a second or outer heating unit 116 spiraling around the inner heating unit 16 and a fluid supply tube 18 extending through the mounting head 14 and along a substantial length of the heating unit 16. The inner and outer heating units are similar in construction to the heating units previously described, with the inner heating unit 16 being sized to slip through the tank opening and the outer heating unit 116 having an outer diameter, as previously described, that is larger than the tank opening so that the liquid level transducer 180 turned or twisted through the tank opening to install the transducer in the tank. With this arrangement, the inner and outer heating units provide more surface area for thawing or warming the fluid to be measured at an increased rate without increasing the overall size of the liquid level transducer so that it can fit within a standard tank opening.

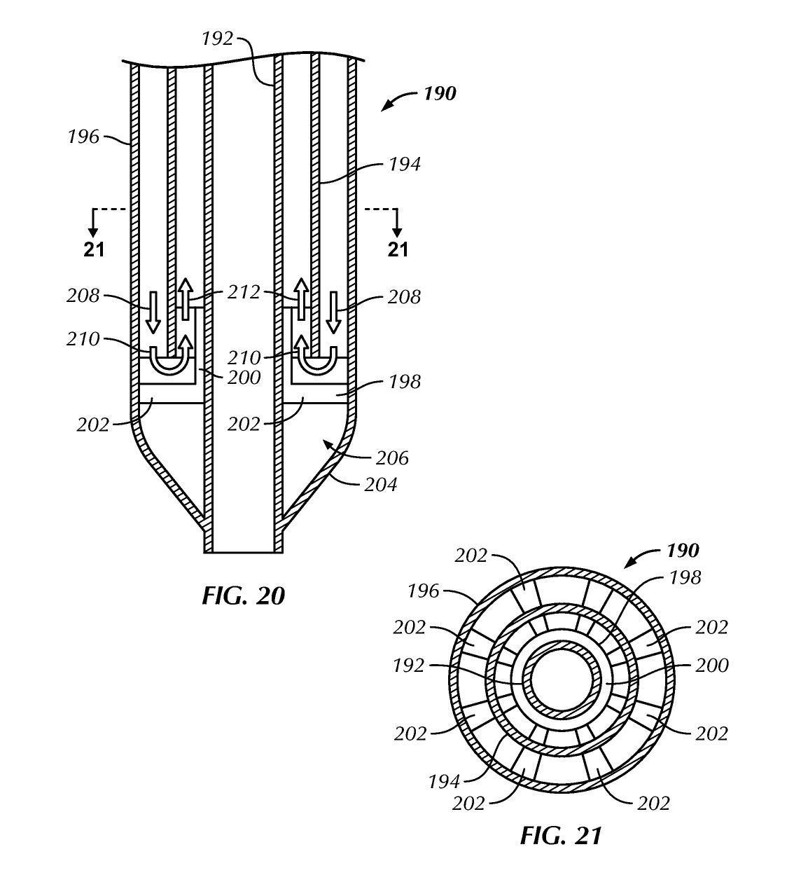

Referring now to FIGS. 20 and 21, a lower portion of a liquid level transducer 190 in accordance with a further embodiment of the invention is illustrated. The liquid level transducer 190 preferably includes a sensor tube 192 located within a heating unit which preferably includes an inner heating fluid return tube 194 which is in turn located within an outer heating fluid supply tube 196. The sensor tube 192 is preferably connected to the outer supply tube 196 via a connector 198 that preferably includes a hub 200 that preferably encircles and connects to the inner return tube 194 and spokes 202 that extend radially outwardly from the hub 200 and connect to the outer supply tube 196. A lower end 204 of the outer supply tube 196 preferably tapers toward the sensor tube 192 to create an internal chamber 206 that communicates with both the inner return tube and outer supply tube. In operation, heating fluid from a fluid source (not shown) such as previously described, is directed down into the outer supply tube 196, as shown by arrows 208, to thereby heat the outer tube and the contents within the tank in the vicinity of the outer tube, and then up into the inner return tube 194, as shown by arrows 210, 212, where it exits the transducer 190. It will be understood that the inner tube 194 can alternatively receive heating fluid and the outer tube 196 can function as the fluid return conduit without departing from the spirit and scope of the invention.

The inner return tube 194 and/or outer supply tube 196 can be constructed of stiff or flexible material. In accordance with one preferred embodiment of the invention, the inner tube 194 is constructed of a flexible material that is compatible to the heating fluid such as rubber, polyurethane, vinyl, and so on, while the outer tube 196 is constructed of a more rigid or stiff material such as stainless steel, aluminum, other metals, and so on. However, it will be understood that the inner and outer tubes can be constructed of any suitable materials without departing from the spirit and scope of the invention.

The sensor tube 192 preferably houses a liquid level probe such as a reed-switch-type probe as previously shown and described. However, it will be understood that the present invention is not limited thereto as other linear-type liquid level measurement sensors can be used, including but not limited to, capacitance, heated wire, ultrasonic, optical, and so on, as well as non-linear-type sensors such as resistance-type pivoting float arms

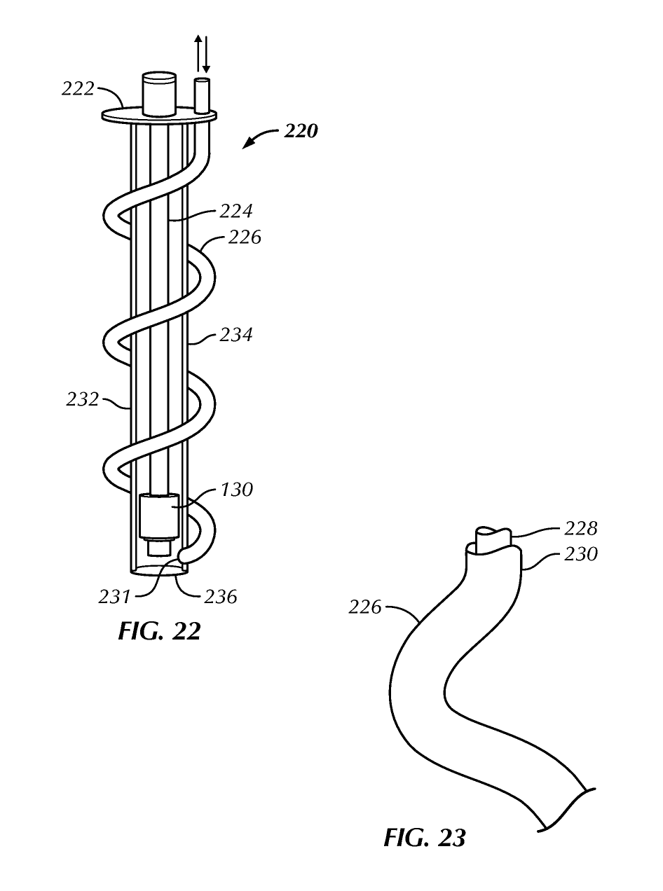

Referring now to FIGS. 22 and 23, a liquid level transducer 220 in accordance with yet another embodiment of the invention is illustrated. The transducer 220 preferably includes a mounting head 222, an elongate sensing probe 224 extending through the mounting head 114 and downwardly therefrom, and a helically-shaped heating unit 226 extending through the mounting head 222 and spiraling around the sensing probe 224.

The sensing probe 224 is preferably similar in construction to the sensing probe 112 with float 130 as previously described. The heating unit 226 preferably includes an inner heating fluid return tube 228 located within an outer heating fluid supply tube 230. The inner tube 228 is preferably constructed of a flexible material that is compatible to the heating fluid such as rubber, polyurethane, vinyl, and so on, while the outer tube 230 is constructed of a more rigid or stiff material such as stainless steel, aluminum or other metals, so that the heating unit 226 can be shaped in a quick and easy manner during manufacture through simple bending operations. A lower end 231 of the outer heating unit is sealed so that the heating fluid remains in the heating unit during use. The heating unit 226 in this embodiment is easier to manufacture and requires less material than the spiral heating tube previously described with reference to FIGS. 10 and 19 since the heating unit does not need to spiral back up as in the previous embodiments. As described in the FIG. 19 embodiment, the inner tube 228 of the present embodiment can alternatively receive heating fluid and the outer tube 230 can function as the fluid return conduit without departing from the spirit and scope of the invention.

In accordance with one preferred embodiment of the invention, the heating unit 226 has an outer diameter that is larger than the tank opening, as previously described with respect to FIG. 18. In accordance with another preferred embodiment of the invention, the heating unit 226 has an outer diameter that is smaller than the tank opening so that the liquid level transducer 220 can be installed straight into the tank without the need to twist the transducer.

Rods 232 and 234 or other support structure can extend between the mounting head 222 and a lower base member 236 to provide added support to the liquid level transducer 220.

It will be understood that the term “preferably” as used throughout the specification refers to one or more exemplary embodiments of the invention and therefore is not to be interpreted in any limiting sense.

It will be further understood that the term “connect” and its derivatives refers to two or more parts capable of being attached together either directly or indirectly through one or more intermediate members. In addition, terms of orientation and/or position as may be used throughout the specification denote relative, rather than absolute orientations and/or positions.

It will be further understood that terms of orientation and/or position as may be used throughout the specification, such as upper and lower, horizontal and vertical, inner and outer, and so on, refer to relative rather than absolute orientations and/or positions.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A transducer for determining the level of contents within a container wherein the contents are subjected to at least partial solidification at or below a freezing temperature, the transducer comprising:
a mounting head adapted for connection to the container;
a liquid level sensor adapted to extend into the container from the mounting head; and
a spiral-shaped heating unit comprising a first elongate tube extending through the mounting head and being formed with at least one coil that surrounds at least a portion of the liquid level sensor, the elongate tube being adapted to circulate heating fluid therein to thereby heat the contents of the container at least in the vicinity of the liquid level sensor.

2. A transducer according to claim 1, wherein the tank has an opening with a first diameter and the coil has a second diameter that is larger than the first diameter, such that the spiral-shaped heating unit is screwed into the tank opening during installation.

3. A transducer according to claim 2, wherein the outside diameter is equal to C=A+(A−B), where C is the outside diameter of the coil, A is the diameter of the tank opening, and B is the inside diameter of the coil.

4. A transducer according to claim 2, wherein the heating unit comprises a second elongate tube located within the first elongate tube, the first and second elongate tubes being in fluid communication such that heating fluid is adapted to flow from one of the first and second elongate tubes to the other of the first and second elongate tubes.

5. A transducer according to claim 1, wherein the heating unit comprises a second elongate tube located within the first elongate tube, the first and second elongate tubes being in fluid communication such that heating fluid is adapted to flow from one of the first and second elongate tubes to the other of the first and second elongate tubes.

7. A transducer according to claim 1, and further comprising a fluid supply tube extending through the mounting head, the fluid supply tube extending along the at least one coil of the heating tube to thereby heat the fluid supply tube.

8. A transducer according to claim 7, wherein the liquid level sensor comprises a sensing tube extending through the at least one coil.

9. A transducer according to claim 8, wherein the sensing tube and at least one coil are connected together for structural stability.

10. A transducer according to claim 1, wherein the at least one coil comprises a plurality of coils.

11. A transducer according to claim 10, wherein the first elongate tube is bent and a lower end thereof to thereby create a coiled supply tube segment and a coiled return tube segment, the supply and return tubes extending adjacent to each other.

12. A transducer according to claim 1, and further comprising a second heating unit surrounding the first heating unit, the second heating unit comprising:
a second heating tube extending through the mounting head and having:
first and second upright segments connected via a first lower bend;
a third upright segment connected to the second upright segment via an upper bend; and
a fourth upright segment connected to the third upright segment via a second lower bend;
the first and fourth upright segments being adapted for fluid connection to a fluent heating source for heating the contents of the container.

13. A transducer for determining liquid level within a container having an opening with a first diameter, the transducer comprising:
a mounting head adapted for connection to the container;
a liquid level sensor adapted for extending into the container from the mounting head; and
a heating tube extending through the mounting head and having:
first and second upright segments connected via a first lower bend;
a third upright segment connected to the second upright segment via an upper bend; and
a fourth upright segment connected to the third upright segment via a second lower bend;
the first and fourth upright segments being adapted for fluid connection to a fluent heating source for heating the contents of the container.

14. A transducer according to claim 13, and further comprising a fluid supply tube extending through the mounting head and into a space created by the first through fourth upright segments of the heating tube, wherein the fluid supply tube extends adjacent to at least one of the heating tube segments to thereby heat the fluid supply tube.

15. A transducer according to claim 14, wherein the liquid level sensor comprises a sensing tube extending into the space.

16. A transducer according to claim 15, wherein the sensing tube and the heating tube are connected together for structural stability.

17. A transducer for determining the level of contents within a container wherein the contents are subjected to at least partial solidification at or below a freezing temperature, the transducer comprising:
a mounting head adapted for connection to the container;
a liquid level sensor adapted for extending into the container from the mounting head; and
a heating unit extending through the mounting head and into the container, the heating unit having an outer tube and an inner tube extending inside and along a length of the outer tube, the outer and inner tubes being in fluid communication such that heating fluid is adapted to flow from one of the outer and inner tubes to the other of the outer and inner tubes to thereby heat the contents of the container.

18. A transducer according to claim 17, wherein the liquid level sensor comprises a sensing tube located within the inner tube.

19. A transducer according to claim 18, wherein the inner, outer and sensing tubes extend linearly into the container from the mounting head.

20. A transducer according to claim 17, wherein the heating unit spirals around the liquid level sensor.
